(19) United States
(12) Patent Application Publication
(10) Pub. No.: US 2020/0070520 A1
(43) Pub. Date: Mar. 5, 2020

(54) LIQUID EJECTING HEAD, LIQUID EJECTING APPARATUS, LIQUID EJECTING HEAD CLEANING METHOD, AND LIQUID EJECTING HEAD MANUFACTURING METHOD

(71) Applicant: SEIKO EPSON CORPORATION, Tokyo (JP)

(72) Inventors: Kentaro MURAKAMI, Matsumoto-shi (JP); Katsuhiro OKUBO, Azumino-shi (JP); Hiroyuki HAGIWARA, Matsumoto-shi (JP); Hiroyuki KOBAYASHI, Azumino-shi (JP)

(21) Appl. No.: 16/552,592

(22) Filed: Aug. 27, 2019

(30) Foreign Application Priority Data
Aug. 28, 2018 (JP) 2018-159274

(51) Int. Cl. B41J 2/165; B41J 2/175

(52) U.S. Cl. CPC B41J 2/16526; B41J 2/17563

(57) ABSTRACT

A liquid ejecting head, a liquid ejecting apparatus, a liquid ejecting head cleaning method, and a liquid ejecting head manufacturing method, in which the liquid ejecting head includes a nozzle that ejects a liquid, a liquid supply path that supplies the liquid to the nozzle, a filter that filters the liquid flowing in the liquid supply path, and a liquid discharge path open in the liquid supply path between the filter and the nozzle. The liquid discharge path includes an on-off valve that opens and closes the opening. The on-off valve permits passage of the liquid from a liquid supply path side to a liquid discharge path side while blocking passage of the liquid from the liquid discharge path side to the liquid supply path side.

The present application is based on, and claims priority from JP Application Serial Number 2018-159274, filed Aug. 28, 2018, the disclosure of which is hereby incorporated by reference herein in its entirety.

### BACKGROUND

### 1. Technical Field

The present disclosure relates to a liquid ejecting head such as an ink jet recording head, a liquid ejecting apparatus including the same, a liquid ejecting head cleaning method, and a liquid ejecting head manufacturing method. In particular, the present disclosure relates to a liquid ejecting head, a liquid ejecting apparatus, a liquid ejecting head cleaning method, and a liquid ejecting head manufacturing method, which are configured to remove a foreign matter from a liquid supply path extending from a filter to a nozzle.

### 2. Related Art

A liquid ejecting apparatus is an apparatus that includes a liquid ejecting head and that ejects (discharges) various liquids from the liquid ejecting head. While the above liquid ejecting apparatus includes an image recording apparatus such as, for example, an ink jet printer or an ink jet plotter, in recent years, taking advantage of the strong point of being able to accurately apply a very small amount of liquid to a predetermined position, the liquid ejecting apparatus is applied to various manufacturing apparatuses. For example, the liquid ejecting apparatus is applied to a display manufacturing apparatus that manufactures a color filter of a liquid crystal display and the like, an electrode forming apparatus that forms electrodes of an electroluminescence (EL) display and a field emission display (FED), and a chip manufacturing apparatus that manufactures biochips (biotips). Furthermore, in a recording head for an image recording apparatus, a liquid containing a coloring material is ejected, and in a coloring material ejecting head for a display manufacturing apparatus, liquids containing coloring materials of various colors, namely, red (R), green (G), blue (B), and the like are ejected. Furthermore, in an electrode material ejecting head for an electrode forming apparatus, a liquid containing an electrode material is ejected, and in a bio organic matter ejecting head for a chip manufacturing apparatus, a liquid containing a bio organic matter is ejected.

The liquid ejecting heads of such types include a series of liquid supply paths that extend from a liquid introduction opening, through a common liquid chamber (or a reservoir, also referred to as a manifold) and pressure chambers (also referred to as cavities), and to the nozzles. The liquid ejecting heads generate pressure fluctuations in the liquid inside the pressure chambers with pressure generation sources (also referred to as actuators) such as, for example, piezoelectric elements or heating elements, and use the pressure fluctuations to eject droplets from the nozzles. Furthermore, there are liquid ejecting heads that are provided with a filter that filters air bubbles and foreign matters included in the ink supplied to the nozzles (see JP-A-11-034350, for example).

There are cases in which foreign matters enter the liquid supply path extending from the filter to the nozzles during the manufacturing process of the liquid ejecting head. Such foreign matters include sebum of a worker involved in the manufacturing, machining chips of components of the liquid ejecting head, and excessive adhesive agents bonding the components to each other. Such foreign matters become causes for the interruption of the liquid flow and clogging of the nozzles. Accordingly, a configuration disclosed in JP-A-11-034350 has a structure allowing a filter housing and an ink supply tube to be removed from the liquid ejecting head. Foreign matters are removed by suctioning and cleaning the removed portions. However, in accordance with the above, problems such as structural limitations and complication in structure have occurred. Furthermore, a configuration that includes, in addition to a liquid supply path, a liquid discharging flow path (a discharge tube) configured to discharge a liquid inside a liquid ejecting head and that removes foreign matters by distributing ink from a nozzle side, through the head flow path, and to the liquid discharging flow path (see JP-A-2004-174820, for example).

However, in the configuration in JP-A-2004-174820, during normal use in which the liquid is ejected from the nozzles, various defects have occurred due to the stagnated liquid inside the liquid discharging flow path becoming gradually thick at the stagnated portion, and solid components such as a coloring material and the like contained in the liquid at the stagnated portion settling down. For example, problems such as unevenness in the thickness of the liquid ejected from the nozzles, and the components that has settled down becoming foreign matters clogging the nozzles have occurred due to the liquid at the stagnated portion becoming diffused to the liquid inside the liquid supply path.

### SUMMARY

The present disclosure has been made in view of such circumstances and an object thereof is to provide a liquid ejecting head, a liquid ejecting apparatus, a liquid ejecting head cleaning method, and a liquid ejecting head manufacturing method, which are configured to remove foreign matters from a liquid supply path while suppressing a stagnation of the liquid.

A liquid ejecting head of the present disclosure is proposed to achieve the above object and includes a nozzle that ejects a liquid, a liquid supply path that supplies the liquid to the nozzle, a filter that filters the liquid flowing in the liquid supply path, and a liquid discharge path that is coupled to the liquid supply path between the filter and the nozzle through an opening, in which the liquid discharge path includes an on-off valve that opens and closes the opening. While the on-off valve permits passage of the liquid from a liquid supply path side to a liquid discharge path side, the on-off valve blocks passage of the liquid from the liquid discharge path side to the liquid supply path side.

According to the liquid ejecting head of the present disclosure, since the liquid discharge path is coupled to the liquid supply path through the opening and includes an on-off valve that opens and closes the opening, in a state in which the on-off valve closes the opening, formation of a space between the liquid supply path and the liquid discharge path where the liquid stagnates is suppressed. Accordingly, in a state in which the on-off valve closes the opening, a stagnation of the liquid is suppressed and, on the other hand, in a state in which the on-off valve opens the opening, foreign matter inside the liquid supply path can be discharged from the liquid discharge path. Furthermore, the on-off valve permits passage of the liquid from the liquid supply path side to the liquid discharge path side and, on the other hand, blocks passage of the liquid from the liquid discharge path side to the liquid supply path side; accordingly, even if the liquid were to stagnate in the liquid discharge path, a backflow towards the liquid supply path side is suppressed.

In the above configuration, it is desirable that a configuration satisfying

S×P1s<F≤S×(P1d−P2),

is adopted, where F [N] is force in which the on-off valve closes the opening, P1d [Pa] is a maximum pressure generated in the liquid inside the liquid supply path when a discharging operation that discharges the liquid inside the liquid supply path through the liquid discharge path is performed, P1s [Pa] is a maximum pressure of the liquid inside the liquid supply path other than when the discharging operation is performed, P2 [Pa] is a minimum pressure of the liquid inside the liquid discharge path when the discharging operation is performed, and S [m²] is an area of the opening (note that a negative pressure takes a negative value).

According to such a configuration, during normal times other than when the discharging operation is performed, the on-off valve can be made to close the opening, and when the discharging operation is performed, the on-off valve can be made to open the opening.

Furthermore, in the configuration described above, it is desirable that a configuration in which the opening is formed in a lower surface of the liquid supply path in a gravitational direction is adopted.

According to such a configuration, since the opening is formed in the lower surface of the liquid supply path in the gravitational direction, air bubbles can be made to not easily stagnate in the opening.

Alternatively, in the configuration described above, a configuration in which the opening is formed in an upper surface of the liquid supply path in the gravitational direction can be adopted.

According to such a configuration, since the on-off valve can close the opening using its own weight, regarding the biasing member used in the on-off valve to close the opening, a biasing member with smaller biasing force can be used.

Furthermore, in the configuration described above, it is desirable that a configuration is adopted in which a portion of the on-off valve protrudes to the liquid supply path side with respect to a portion where the on-off valve abuts against a peripheral portion of the opening when the opening is in a closed state.

According to such a configuration, when the opening is in a closed state, since a portion of the on-off valve protrudes to the liquid supply path side with respect to the portion where the on-off valve abuts against the peripheral portion of the opening, a space between the liquid supply path and the liquid discharge path in which the liquid stagnates can be suppressed further from being created. With the above, a stagnation of the liquid in the opening can be suppressed further.

Furthermore, in the configuration described above, it is desirable that a configuration is adopted in which the liquid supply path includes a common liquid chamber commonly provided to a plurality of the nozzles, and in which the liquid discharge path includes, in the liquid supply path, the opening at a position on the filter side with respect to the common liquid chamber.

According to such a configuration, in the liquid supply path, since the liquid discharge path includes the opening at the position on the filter side with respect to the common liquid chamber, foreign matters situated closer to the filter can be discharged easily.

Alternatively, in the configuration described above, a configuration can be adopted in which the liquid supply path includes a common liquid chamber commonly provided to a plurality of the nozzles, and in which the liquid discharge path is open in the common liquid chamber.

According to such a configuration, since the liquid discharge path is open in the common liquid chamber, foreign matters positioned closer to the nozzle can be discharged easily.

Furthermore, in the configuration described above, it is desirable that a configuration in which an area of the opening is smaller than a sectional area of the liquid supply path at the position where the opening is formed is adopted.

According to such a configuration, since the area of the opening is smaller than the sectional area of the liquid supply path, portions where a stagnation tends to occur can be reduced.

Furthermore, in the configuration described above, it is desirable that a configuration in which the area of the opening is smaller than an opening area of the nozzle is adopted.

According to such a configuration, foreign matters having a size that becomes a cause of nozzle clogging can be discharged to the liquid discharge path through the opening.

Furthermore, the liquid ejecting apparatus according to the present disclosure includes a liquid ejecting head having either one of the configurations described above, a pump that creates a pressure difference between the liquid discharge path and the liquid supply path; and a sealing member that seals a surface of the liquid ejecting head in which the nozzle is formed.

According to the present disclosure, other than when the discharging operation, which discharges the liquid inside the liquid supply path through the liquid discharge path, is being performed, while a stagnation of the liquid between the coupling portion between the liquid supply path and the liquid discharge path is suppressed, when the discharging operation is being performed, foreign matters can be discharged from the liquid supply path through the liquid discharge path by creating a pressure difference between the liquid supply path and the liquid discharge path with a drive of the pump and opening the on-off valve.

Furthermore, the liquid ejecting head cleaning method according to the present disclosure is a cleaning method of a liquid ejecting head having either one of the configurations described above and includes performing a discharging operation that discharges a liquid inside the liquid supply path to the liquid discharge path side through the opening by creating a pressure difference between the liquid discharge path and the liquid supply path and opening the on-off valve.

According to the present disclosure, other than during the discharging operation, while a stagnation of the liquid in the coupling portion between the liquid supply path and the liquid discharge path is suppressed, during the discharging operation, foreign matters can be discharged from the liquid supply path through the liquid discharge path by creating a pressure difference between the liquid supply path and the liquid discharge path and opening the on-off valve.

Furthermore, in the cleaning method described above, it is desirable that the pressure difference be created by reducing the pressure inside the liquid discharge path in the discharging operation.

According to such a cleaning method, since the on-off valve is opened with the pressure difference created by reducing the pressure in the liquid discharge path, even when the liquid is stagnated inside the liquid discharge path, a backflow of the stagnated liquid to the liquid supply path side when the on-off valve is opened can be suppressed further. Furthermore, if the pressure of the liquid supply path side is not increased in the discharging operation, the foreign matter inside the liquid supply path will be suppressed from being sent to the nozzle side; accordingly, difficulty in discharging the foreign matter can be prevented from occurring.

Furthermore, in the cleaning method described above, it is desirable that the pressure of the ink in the nozzle be positive before the pressure inside the liquid discharge path is reduced.

According to such a cleaning method, even when there is a stagnation of the liquid in the liquid discharge path, the backflow of the stagnated liquid to the liquid supply path side when the on-off valve is opened can be suppressed more effectively.

Furthermore, in the cleaning method described above, it is desirable that the pressure difference be created in the discharging operation by both reducing the pressure inside the liquid discharge path and increasing the pressure inside the liquid supply path.

According to such a configuration, since the pressure difference is created in the discharging operation by both reducing the pressure inside the liquid discharge path and increasing the pressure inside the liquid supply path, even when there is a restriction (in other words, an upper limit) in the pressure value when reducing the pressure inside the liquid discharge path, the on-off valve can be opened without any problem. Furthermore, air bubbles can be suppressed from being drawn into the liquid supply path from the nozzle.

Furthermore, in the cleaning method described above, the pressure inside the liquid discharge path may be reduced after the pressure inside the liquid supply path has been increased.

According to such a cleaning method, by increasing the pressure inside the liquid supply path in advance when opening the on-off valve, the backflow of the liquid from the liquid discharge path side to the liquid supply path side can be suppressed. Furthermore, air bubbles can be suppressed further from being drawn into the liquid supply path from the nozzle.

Alternatively, in the cleaning method described above, the pressure inside the liquid supply path may be increased after the pressure inside the liquid discharge path has been reduced.

According to such a configuration, by reducing the pressure inside the liquid discharge path in advance when opening the on-off valve, the liquid stagnated in the liquid discharge path can be discharged more quickly.

Furthermore, in the cleaning method described above, it is desirable that the surface of the liquid ejecting head in which the nozzle is formed be sealed with the sealing member before the discharging operation.

According to such a cleaning method, leakage of the liquid inside the liquid supply path from the nozzle and air bubbles being drawn into the liquid supply path from the nozzle can be suppressed during the discharging operation. Furthermore, even when the liquid were to leak out from the nozzle, the liquid can be promptly collected to the sealing member.

Furthermore, in the cleaning method described above, it is desirable that the liquid be discharged from the liquid discharge path in the discharging operation by supplying the liquid into the liquid supply path from the nozzle side.

According to such a cleaning method, by discharging the liquid from the liquid discharge path by supplying the liquid into the liquid supply path from the nozzle side, the inside of the liquid supply path can be made cleaner.

Furthermore, in the liquid ejecting head manufacturing method according to the present disclosure, either one of the liquid ejecting head cleaning methods described above is applied.

### BRIEF DESCRIPTION OF THE DRAWINGS

FIG. 1 is a front view illustrating a configuration of an embodiment of a liquid ejecting apparatus.

FIG. 2 is a cross-sectional view illustrating a configuration of an embodiment of the liquid ejecting head.

FIG. 3 is an enlarged view illustrating a coupling portion between an ink supply path and an ink discharge path.

FIG. 4 is an enlarged view illustrating the coupling portion between the ink supply path and the ink discharge path.

FIG. 5 is a block diagram illustrating an electrical configuration of the liquid ejecting apparatus.

FIG. 6 is a flowchart illustrating a discharging operation.

FIG. 7 is an enlarged view illustrating a coupling portion between an ink supply path and an ink discharge path, according to a first modification.

FIG. 8 is a cross-sectional view of a liquid ejecting head according to a second modification.

FIG. 9 is an enlarged view illustrating a coupling portion between an ink supply path and an ink discharge path, according to a third modification.

FIG. 10 is an enlarged view illustrating a coupling portion between an ink supply path and an ink discharge path, according to a fourth modification.

FIG. 11 is a cross-sectional view illustrating an example of a configuration of a cleaning device of a liquid ejecting head according to a second embodiment.

### DESCRIPTION OF EXEMPLARY EMBODIMENTS

Hereinafter, embodiments for carrying out the present disclosure will be described with reference to the drawings. Note that in the embodiments described below, various limitations are set as specific examples suitable for the present disclosure; however, the scope of the present disclosure is not limited to the configurations described below unless there is a description particularly implying that the present disclosure is limited thereby. Furthermore, the following description will be given with an ink jet recording apparatus (hereinafter, a printer) 1, on which an ink jet recording head (hereinafter, a recording head) 8 that is a type of liquid ejecting head is mounted, as an example of the liquid ejecting apparatus of the present disclosure.

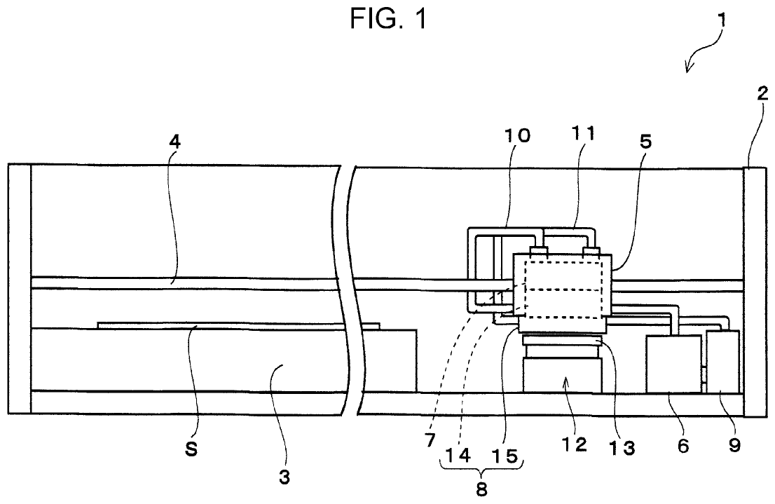

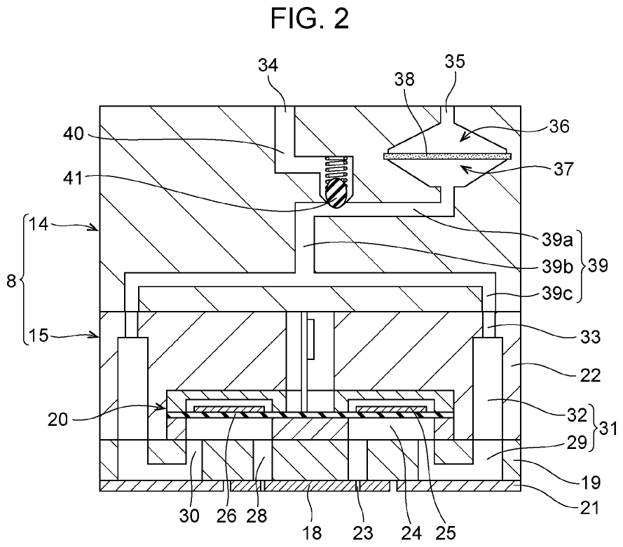

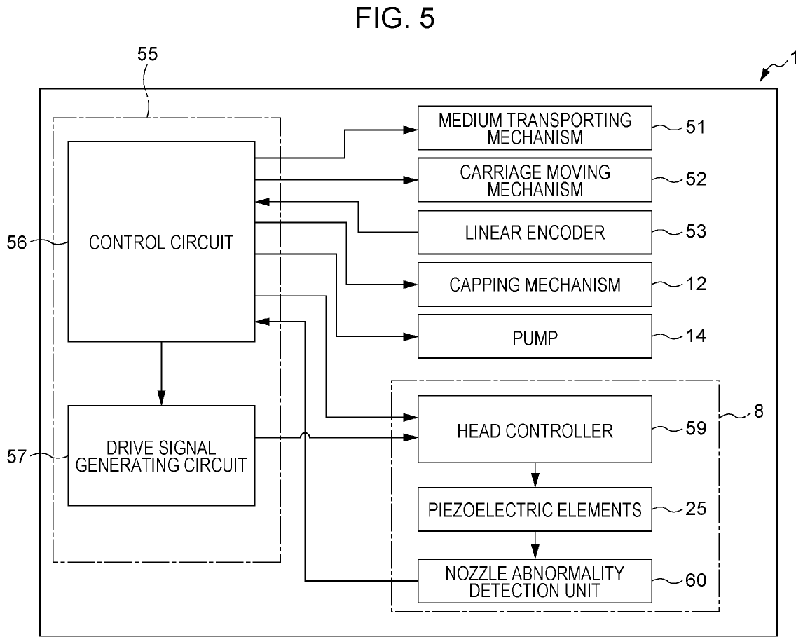

FIG. 1 is a front view illustrating an example of a configuration of the printer 1. The printer 1 according to the present embodiment is an apparatus that records and prints an image, text, and the like with arrays of dots, which are liquid ink (a type of liquid in the present disclosure) ejected from a recording head 8 and applied on a surface of a print medium S such as a recording sheet, a piece of fabric, or a resin film. The printer 1 includes a frame 2 and a platen 3 disposed in the frame 2. The print medium S is transported onto the platen 3 with a medium transporting mechanism 51 (see FIG. 5). A guide rod 4 parallel to the platen 3 is provided inside the frame 2. The recording head 8 and a carriage 5, in which a sub tank 7 that sends and receives ink between the recording head 8 and an ink tank 6 is accommodated, are supported by the guide rod 4 in a slidable manner. The carriage 5 is configured to reciprocate along the guide rod 4 with a carriage moving mechanism 52 (see FIG. 5) in a main scanning direction orthogonal to a direction in which the print medium S is transported. The printer 1 according to the present embodiment performs a printing operation (in other words, a recording operation) by reciprocating the carriage 5 relative to the print medium S while ejecting ink from nozzles 23 (see FIG. 2 and other figures) of a head unit 15.

The ink tank 6, which is a type of liquid reservoir, is mounted on one side of the frame 2. After being introduced into the sub tank 7 through a supply tube 10 with a pressure of a pump 9, the ink stored in the ink tank 6 is supplied to the recording head 8. Furthermore, in the present embodiment, the pump 9 is normally used to apply pressure inside the ink tank 6 to send the ink to the recording head 8. However, by being coupled to an ink discharge path 40 (corresponding to a liquid discharge path of the present disclosure), a pressure difference that opens an on-off valve 41 is created between an ink supply path (corresponding to a liquid supply path of the present disclosure), which extends from a filter 38 to the nozzle 23 through a communication flow path 39 as illustrated in FIG. 2, and the ink discharge path 40; accordingly, a discharging operation that discharges the ink inside the ink supply path through the ink discharge path 40 can be performed. In the present embodiment, ink, foreign matter, and the like discharged through the ink discharge path 40 by the discharging operation are returned to the ink tank 6 through a discharge tube 11. An adjusting unit that adjusts a supply pressure of the ink to the recording head 8 and other members are provided inside the sub tank 7 mounted in the carriage 5. The recording head 8 according to the present embodiment includes a filter unit 14 and the head unit 15. Details of the recording head 8 will be described later.

A capping mechanism 12 including a cap 13 (a type of sealing member in the present disclosure) that seals a nozzle formation surface of the head unit 15 is provided inside the frame 2 and at a home position provided on one side in a moving area of the head unit 15. The capping mechanism 12 suppresses a solvent of the ink from evaporating from the nozzles 23 by sealing the nozzle formation surface of the head unit 15, which is in a standby state at the home position, with the cap 13. Furthermore, in a state in which the nozzle formation surface of the head unit 15 is sealed (in other words, in a capped state), the capping mechanism 12 is capable of performing a cleaning operation that forcibly suctions the ink and foreign matters from the nozzles 23 by bringing the insides of sealed spaces to a negative pressure. Furthermore, in the discharging operation, by bringing the nozzle formation surface to a capped state, air bubbles can be suppressed from being drawn into the ink supply path through the nozzles 23 when the pressure in the ink discharge path 40 is reduced. With the above, a state in which meniscuses are not formed in a normal manner inside the nozzles 23, in other words, a state in which the meniscuses are broken, can be suppressed from occurring. Furthermore, in a configuration in which the pressure is increased in the discharging operation from upstream of the ink supply path, in other words, in a configuration in which the discharge of the ink from the ink discharge path 40 is assisted by increasing the pressure inside the ink supply path, by bringing the nozzle formation surface to the capped state, the pressure when assisting can be prevented from escaping to the nozzle 23 side, in other words, the ink can be prevented from leaking from the nozzles 23. Furthermore, even when the ink were to leak from the nozzles 23, the ink that has leaked out can be collected to the cap 13 in a prompt manner.

FIG. 2 is a schematic diagram illustrating a configuration of the recording head 8. The recording head 8 according to the present embodiment includes the filter unit 14 and the head unit 15. A configuration of the head unit 15 will be described first. The head unit 15 is formed as a unit by stacking and bonding, with an adhesive agent, a plurality of components such as a nozzle plate 18, a communicating plate 19, an actuator substrate 20, a compliance substrate 21, and a case 22.

The actuator substrate 20 according to the present embodiment includes a plurality of pressure chambers 24 that are each in communication with a corresponding one of the plurality of nozzles 23 formed in the nozzle plate 18, and a plurality of piezoelectric elements 25 that are actuators that each create pressure fluctuation in the ink inside the corresponding pressure chamber 24. Diaphragms 26 are provided between the pressure chambers 24 and the piezoelectric elements 25. A portion of each pressure chamber 24 is sectioned by sealing an upper opening of the pressure chamber 24 with a corresponding diaphragm 26. The diaphragm 26 is formed of an elastic film formed of silicon dioxide (SiO₂), and an insulating film that is formed on the elastic film and that is formed of zirconium oxide (ZrO₂). Furthermore, the piezoelectric elements 25 are layered on areas on the diaphragms 26 that correspond to the pressure chambers 24. The piezoelectric element 25 according to the present embodiment is a so-called flexure mode piezoelectric element. In the piezoelectric element 25, for example, a lower electrode layer, a piezoelectric layer, and an upper electrode layer (all not shown) are sequentially layered on the diaphragm 26. The piezoelectric element 25 configured in the above manner becomes flexurally deformed when an electric field corresponding to the electric potential difference between the two electrodes is applied between the lower electrode layer and the upper electrode layer.

The communicating plate 19 that has an area that is larger than that of the actuator substrate 20 is bonded on a lower surface of the actuator substrate 20. Nozzle communication holes 28 that communicate the pressure chambers 24 and the nozzles 23 to each other, stored liquid chambers 29 commonly provided to the pressure chambers 24, and individual communication holes 30 that communicate the stored liquid chambers 29 and pressure chambers 24 to each other are formed in the communicating plate 19 according to the present embodiment. The stored liquid chambers 29 are liquid chambers that extend in a direction in which the nozzles 23 are parallelly arranged. The stored liquid chambers 29 form common liquid chambers 31 together with the introduction liquid chambers 32 described later. In the present embodiment, two stored liquid chambers 29 are formed so as to correspond to two lines of nozzles 23 provided in the nozzle plate 18. A plurality of individual communication holes 30 are formed in a nozzle row direction so as to correspond to the pressure chambers 24. The individual communication holes 30 are in communication with end portions of the pressure chambers 24. The end portions are on the sides opposite to the portions of the pressure chambers 24 that are in communication with the nozzle communication holes 28.

The nozzle plate 18 in which the plurality of nozzles 23 are formed is bonded to a middle portion of a lower surface of the communicating plate 19 described above. The nozzle plate 18 according to the present embodiment is a plate material having an external shape that is smaller than that of the communicating plate 19. The nozzle plate 18 is bonded with an adhesive agent or the like on the lower surface of the communicating plate 19 at a position off from that of openings of the stored liquid chambers 29 and at an area in which the nozzle communication holes 28 are open, so that the nozzle communication holes 28 and the nozzles 23 are in communication with each other. A total of two lines of nozzle rows formed by providing a plurality of nozzles 23 in rows are formed in the nozzle plate 18 according to the present embodiment. Furthermore, the compliance substrate 21 is bonded to the lower surface of the communicating plate 19 at a position off from that of the nozzle plate 18. The compliance substrate 21 being positioned and bonded to the lower surface of the communicating plate 19 seals the openings of the stored liquid chambers 29 at the lower surface of the communicating plate 19. The compliance substrate 21 has a function of mitigating the pressure fluctuation inside the ink supply path, in particular, inside the common liquid chambers 31.

The actuator substrate 20 and the communicating plate 19 are fixed to the case 22. The introduction liquid chambers 32 forming the common liquid chambers 31 by being in communication with the stored liquid chambers 29 of the communicating plate 19 are formed inside the case 22 and at both sides interposing the actuator substrate 20 in between. Furthermore, introduction openings 33 that are open in an upper surface of the case 22 and that are in communication with the introduction liquid chambers 32 are provided. The introduction openings 33 are in communication with the communication flow paths 39 in the filter unit 14 Accordingly, the ink sent from the sub tank 7 and the filter unit 14 is introduced into the introduction openings 33, the introduction liquid chambers 32, and the stored liquid chambers 29, and is supplied from the stored liquid chambers 29 to each pressure chamber 24 through the corresponding individual communication hole 30. Furthermore, in the recording head 8 configured in the above described manner, by driving the piezoelectric elements 25 when the flow paths extending from the common liquid chambers 31 through the pressure chambers 24 and to the nozzles 23 are filled with ink, pressure fluctuations occur in the ink inside the pressure chambers 24, and with the above pressure oscillation, the ink is ejected from predetermined nozzles 23. Note that the liquid ejecting head is not limited to the recording head 8 described as an example and liquid ejecting heads with various known configurations may be adopted.

The filter unit 14 according to the present embodiment includes, inside thereof, a filter chamber (more specifically, an upper filter chamber 36 and a lower filter chamber 37), the filter 38, the communication flow path 39, the ink discharge path 40, and the on-off valve 41. Furthermore, the filter unit 14 includes an inflow port 35 through which the ink from the ink tank 6 side flows in, and a discharge port 34 through which the ink from the ink discharge path 40 is discharged. The inflow port 35 is coupled to the sub tank 7, and the ink from the sub tank 7 is introduced thereto. The ink introduced into the inflow port 35 flows into the filter chamber. The filter chamber includes the upper filter chamber 36 and the lower filter chamber 37. Furthermore, the filter 38 is provided so as to partition the filter chambers 36 and 37 from each other. The upper filter chamber 36 is a space in which sectional areas thereof become gradually enlarged (in other words, become gradually larger) from the upper side, in other words, from the inflow port 35 side that is opposite the filter 38, towards the lower side, in other words, towards the filter 38 side. The filter 38 is disposed so as to block the flow path of the filter unit 14, and collects air bubbles and foreign matters mixed in the ink by filtering the ink that has flowed into the filter chamber. The lower filter chamber 37 is a space in which sectional areas thereof become gradually reduced (in other words, becomes gradually smaller) from the upper side, in other words, from the filter 38 side, towards the lower side, in other words, towards the side opposite the filter 38 side. The communication flow path 39 is in communication with a bottom portion of the lower filter chamber 37. The communication flow path 39 includes a lateral passage 39a that extends substantially parallel to upper and lower surfaces of the filter unit 14, a vertical passage 39b that extends in a height direction of the filter unit 14 and that is in communication with an end portion of the lateral passage 39a, the end portion being situated on a side opposite the filter chamber side, and a branching passage 39c that bifurcates from a lower end of the vertical passage 39b. Ends of each branching passage 39c are, at the bottom portion of the filter unit 14, in communication with the introduction openings 33 of the head unit 15.

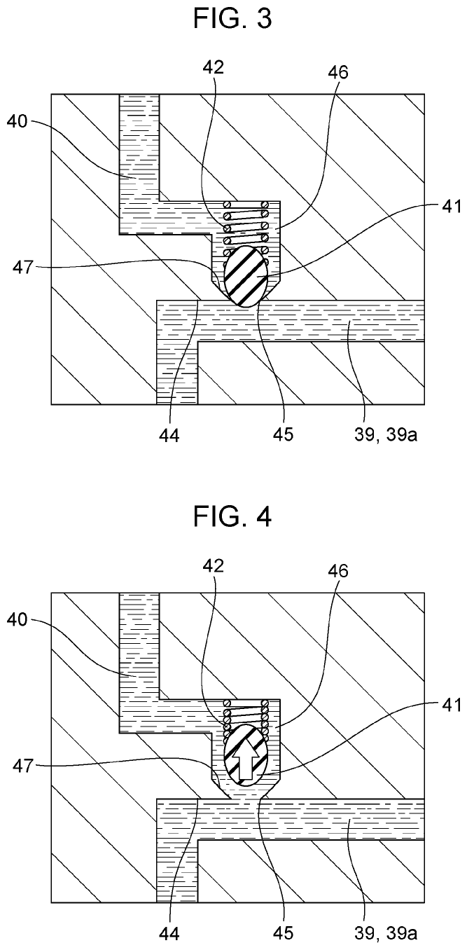

FIGS. 3 and 4 are enlarged views illustrating a coupling portion between the communication flow path 39 and the ink discharge path 40. FIG. 3 illustrates a state in which the on-off valve 41 serving as a valve element has closed an opening 45, and FIG. 4 illustrates a state in which the on-off valve 41 has opened the opening 45. In the ink supply path of the recording head 8 in the present embodiment, the ink discharge path 40 is, through the opening 45, in communication with the lateral passage 39a of the communication flow path 39 at a position on the filter 38 side (in other words, upstream) with respect to the common liquid chambers 31. The ink discharge path 40 is a flow path in communication with the discharge tube 11 in which the other end of the ink discharge path 40 on the side opposite the side in communication with the lateral passage 39a is open as the discharge port 34 at an upper surface of the filter unit 14. The ink discharge path 40 according to the present embodiment is in communication with an upper surface 44 that is, among the surfaces of the walls that define the lateral passage 39a, a surface positioned on the upper side in the gravitational direction. The above communicating portion is the opening 45. While an area of the opening 45 is set smaller than a flow-path sectional area of the communication flow path 39 and the flow-path sectional area of the ink discharge path 40, the area of the opening 45 is set larger than an opening area of each nozzle 23 in the nozzle formation surface. As described above, since the area of the opening 45 is smaller than the sectional area of the communication flow path 39 (in other words, the ink supply path), portions that tend to become stagnated can be reduced in a greater manner. Furthermore, since the area of the opening 45 is larger than the opening area of each nozzle 23, foreign matters having sizes that cause clogging of the nozzles 23 can be easily discharged to the ink discharge path 40 through the opening 45.

Furthermore, the ink discharge path 40 includes the on-off valve 41 that opens and closes the opening 45. The on-off valve 41 is provided in the valve element accommodation chamber 46 formed adjacent to the opening 45. The valve element accommodation chamber 46 is, for example, a cylindrical space that constitutes a portion of the ink discharge path 40. Flow-path sectional areas of the valve element accommodation chamber 46 in a lower portion (in other words, in the vicinity of the opening 45) become gradually smaller towards the opening 45 and, accordingly, the above portion includes a tapered surface 47 that is inclined downwards towards the opening 45 so as to have a substantially funnel shape. In other words, a peripheral portion of the opening 45 on the valve element accommodation chamber 46 side is a tapered surface 47. The on-off valve 41 is configured to switch between a valve open state that permits the introduction of ink from the communication flow path 39 side towards the ink discharge path 40 side, and a valve closed state that blocks the introduction of ink from the communication flow path 39 side towards the ink discharge path 40 side. The on-off valve 41 is disposed inside the valve element accommodation chamber 46 in a state in which the on-off valve 41 is biased towards a valve closed position side with a biasing member 42 such as a coil spring or the like. The on-off valve 41 having such a configuration can be referred to as a check valve that, while permitting passage of ink from the ink supply path side towards the ink discharge path 40 side, blocks passage of ink from the ink discharge path 40 side towards the ink supply path side.

The on-off valve 41 according to the present embodiment has a prolate spheroid shape (in other words, an ellipsoid of revolution) elongated in an opening and closing direction. The on-off valve 41 is formed of an elastic material such as, for example, an elastomer or silicone rubber. Note that a configuration in which a surface of a metal prolate spheroid is covered with an elastic material can be adopted as the on-off valve 41. A diameter of the on-off valve 41 in the minor axis (in other words, the maximum diameter) is set smaller than the flow-path sectional area of the valve element accommodation chamber 46 and is set larger than the area of the opening 45. Accordingly, the opening 45 can be sealed in a liquid tight manner in the valve closed state illustrated in FIG. 3 by having the elastic material of the on-off valve 41 abut against and adhere to the tapered surface 47 at the periphery of the opening 45 with the biasing force of the biasing member 42. As described above, a portion of the tapered surface 47 functions as a valve seat (in other words, as a seal portion). In the present embodiment, in the valve closed state, a portion of the on-off valve 41 slightly protrudes inside the ink supply path from a seal portion at which the on-off valve 41 abuts against the tapered surface 47 at the periphery of the opening 45. With the above, in the valve closed state, no space in which the ink stagnates (in other words, a depression or a recess) is created in the opening 45, which is a coupling portion (in other words, a boundary portion) between the ink supply path and the ink discharge path 40. As a result, a stagnation of the ink in the opening 45 can be suppressed further.

The biasing member 42 accommodated inside the valve element accommodation chamber 46 biases the on-off valve 41 from the ink discharge path 40 side towards the communication flow path 39 (in other words, the ink supply path) side. Furthermore, the biasing member 42 keeps the on-off valve 41 at the valve closed position, in which the on-off valve 41 is adhered to the tapered surface 47 at the periphery of the opening 45, until the pressure difference between the ink supply path and the ink discharge path 40 reaches a predetermined value. The present embodiment is designed so that force in which the on-off valve 41 closes the opening 45 satisfies the following expression (1).

S×P1s<F≤S×(P1d−P2) (1),

where F [N] is the force in which the on-off valve 41 closes the opening 45 (the biasing force of the biasing member 42 and force created by the weight of the on-off valve 41, and the like), P1d [Pa] is the maximum pressure generated in the ink inside the ink supply path when the discharging operation that discharges the ink inside the ink supply path through the ink discharge path 40 is performed, P1s [Pa] is the maximum pressure of the ink inside the ink supply path other than when the above discharging operation is performed, more specifically, when the printing operation that is normally performed in the printer 1 is performed or when the cleaning operation and the like described above is performed, P2 [Pa] is the minimum pressure of the ink inside the ink discharge path 40 in the discharging operation, and S [m²] is the area of the opening 45. Note that the pressure will take a negative value when the pressure is negative (in other words, when taking a value lower than the atmospheric pressure) by suctioning. Furthermore, the area S of the opening 45 is a value approximate to a pressure receiving area of the on-off valve 41. With the above, in the printer 1, when during normal use such as during a printing operation and the like other than when the discharging operation is performed, the on-off valve 41 closes the opening 45 and there will be no ink flowing between the ink supply path and the ink discharge path 40 through the opening 45. Furthermore, when the discharging operation is executed, the on-off valve 41 is configured to open the opening 45. Note that in the present embodiment, since the opening 45 is formed in the upper surface 44 that is, among the wall surfaces defining the lateral passage 39a of the ink discharge path 40, on the upper side in the vertical direction, the on-off valve 41 can close the opening 45 using its own weight; accordingly, regarding the biasing member 42 that is used by the on-off valve 41 to close the opening 45, a biasing member that has a smaller biasing force can be used.

An electrical configuration of the printer 1 will be described next.

FIG. 5 is a block diagram illustrating an electrical configuration of the printer 1. The printer 1 according to the present embodiment includes the medium transporting mechanism 51, the carriage moving mechanism 52, a linear encoder 53, the capping mechanism 12, the pump 9, the recording head 8, and a printer controller 55 that controls the above.

The printer controller 55 according to the present embodiment includes a control circuit 56, a drive signal generating circuit 57, and the like. The control circuit 56 is an arithmetic processing unit that performs control of the entire printer and includes a CPU, a storage device, and the like (all not shown). The control circuit 56 controls each of the units in the printer 1 according to a program and the like stored in the storage device. Furthermore, during the printing operation, based on print job data sent from an external device and the like, the control circuit 56 according to the present embodiment generates ejection data for ejecting ink from the nozzles 23 of the recording head 8 and sends the ejection data to a head controller 59 of the recording head 8. Furthermore, the control circuit 56 generates a timing signal from an encoder signal that is output from the linear encoder 53 generated according to the movement (in other words, a main scanning) of the carriage 5. The drive signal generating circuit 57 outputs the drive signal each time the timing signal is received. Based on the waveform data related to the waveform of the drive signal, the drive signal generating circuit 57 generates an analog voltage signal and amplifies the analog voltage signal with an amplifier circuit to generate the drive signal. The drive signal generated by the drive signal generating circuit 57 is sent to the head controller 59 of the recording head 8.

The carriage moving mechanism 52 includes a drive motor (a DC motor, for example, not shown) and the like that moves the carriage 5 through a timing belt and the like. The carriage moving mechanism 52 moves the recording head 8, which is mounted in the carriage 5, along the guide rod 4 in the main scanning direction. The medium transporting mechanism 51 sequentially sends the print medium S onto the platen 3 and performs sub scanning. Furthermore, the linear encoder 53 sends, to the control circuit 56 of the printer controller 55, an encoder signal corresponding to the scanning position of the recording head 8 mounted in the carriage 5 as positional information in the main scanning direction. The control circuit 56 ascertains the scanning position (the current position) of the recording head 8 based on the received encoder signal from the linear encoder 53 side.

The recording head 8 includes the head controller 59, the piezoelectric elements 25, and a nozzle abnormality detection unit 60. The nozzle abnormality detection unit 60 is a mechanism that detects an ejection abnormality (in other words, an ejection failure) of each nozzle 23 of the recording head 8. An inspection of whether the ink from the nozzles 23 is ejected normally is performed during the printing operation with the nozzle abnormality detection unit 60. The nozzle abnormality detection unit 60 according to the present embodiment is configured to output an electromotive force signal of the piezoelectric element 25 as a detection signal to the control circuit 56. The electromotive force signal of the piezoelectric element 25 is based on the vibration generated in the ink inside the pressure chamber 24 when the piezoelectric element 25 is driven during the ejection of the ink. Based on the detection signal output from the nozzle abnormality detection unit 60, the control circuit 56 determines whether there is an abnormality in the ejection of the ink from the nozzles 23. During abnormalities such as nozzle omission in which there are some nozzles 23 in which the ink is not ejected or, even when the ink is ejected from the nozzles 23, the amount of ink and the flying velocity (the initial velocity) are extremely low compared to those of a normal nozzle 23, the periodic component and the amplitude component of the detection signal described above differ compared with the period and amplitude during normal times that are obtained in advance. Particularity, when there are foreign matters inside the ink supply path, the amplitude and the period of the detection signal significantly change from those during normal times. The detection of ejection abnormality based on the detection signal, in other words, on the electromotive force signal, is a known method and a detailed description thereof will be omitted; however, the above detection method is capable of detecting an ejection abnormality caused by air bubbles. Note that the method of detecting the ejection abnormality is not limited to the exemplified method that uses electromotive force of the piezoelectric elements 25, and various known methods such as, for example, a method that optically detects the ink droplets ejected from the nozzles 23 can be adopted.

In the printing operation of the printer 1 configured in the above manner, an image and the like is printed by sequentially transporting a print medium S with the medium transporting mechanism 51 and ejecting the ink that is a type of liquid from the nozzles 23 of the recording head 8 as ink droplets while moving the recording head 8 relative to the print medium S in the main scanning direction and applying the ink droplets onto the print medium S. Furthermore, the printer 1 according to the present embodiment performs the discharging operation that discharges the ink from the ink supply path through the ink discharge path 40 when, for example, an ejection abnormality is detected by the nozzle abnormality detection unit 60. The above point will be described below.

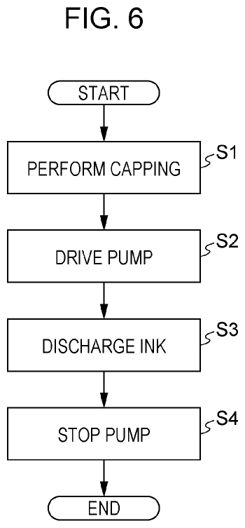

FIG. 6 is a flowchart illustrating a flow of a process performed in the discharging operation of the printer 1 according to the present embodiment. As described above, in the printer 1, other than when the discharging operation is performed, in other words, during the printing operation or during the cleaning operation and the like described above, the state in which the opening 45 is closed by the on-off valve 41 is maintained as illustrated in FIG. 3 since the force F of the on-off valve 41 closing the opening 45 is larger than the load (in other words, S×P1s) that the on-off valve 41 receives from the ink supply path side when at maximum pressure P1s generated in the ink inside the ink supply path. With the above, the ink supply path from the filter 38 to the nozzles 23 that passes through the communication flow path 39, and the ink discharge path 40 are cutoff from each other with the on-off valve 41, and the flow of the ink between the ink supply path and the ink discharge path 40 is blocked.

Furthermore, when a timing to perform the discharging operation is reached, such as when the nozzle abnormality detection unit 60 detects an ejection abnormality, the control circuit 56 positions the recording head 8 to the home position, and the capping mechanism 12 performs capping of the nozzle formation surface of the recording head 8 (step S1). Subsequently, the control circuit 56 increases the pressure inside the ink supply path by sending the ink inside the ink tank 6 to the ink supply path of the recording head 8 through the supply tube 10 by driving the pump 9, and reduces the pressure inside the ink discharge path 40 through the discharge tube 11 (step S2). With the above, the pressure inside the ink supply path becomes larger than the pressure inside the ink discharge path 40, and the pressure difference between the ink supply path and the ink discharge path 40 becomes larger. In the present embodiment, while an exemplary configuration in which the increase in pressure inside the ink supply path and the decrease in pressure inside the ink discharge path 40 are performed by a common pump 9 has been described, not limited to the above, a configuration can be adopted in which the increase in pressure and the decrease in pressure are performed by separate pumps. Note that since the nozzle formation surface is sealed with the cap 13, the pressure inside the ink supply path does not escape externally through the nozzles 23.

Furthermore, when the load or S×(P1d−P2) which the on-off valve 41 receives from the ink supply path side owing to the pressure difference between the positive pressure on the ink supply path side and the negative pressure on the ink discharge path 40 side is larger than the force F of the on-off valve 41 closing the opening 45, the on-off valve 41 countering the biasing force of the biasing member 42 moves in the opening direction, in other words, the on-off valve 41 moves towards the side distancing away from the opening 45. With the above, as illustrated in FIG. 4, the state in which the on-off valve 41 is adhered to the tapered surface 47 at the peripheral portion of the opening 45 is cancelled and the valve open state is reached. In other words, the ink supply path and the ink discharge path 40 communicate with each other through the opening 45 and the ink and foreign matter is permitted to flow from the ink supply path side to the ink discharge path 40 side. Furthermore, when there is a foreign matter inside the ink supply path, the foreign matter is discharged together with the ink inside the ink supply path towards the ink discharge path 40 side through the opening 45 (step S3). In the present embodiment, the ink that has been discharged to the ink discharge path 40 side is returned to the ink tank 6 from the discharge port 34 and through the discharge tube 11 after passing through a filter (not shown). Note that the ink and the foreign matter from the ink discharge path 40 may be discharged to a waste liquid tank or the like (not shown) through the discharge tube 11.

After the pump 9 has been driven for a predetermined time, that is, for a time until the ink amounting to the volume of the ink supply path has flowed, the drive of the pump 9 is stopped (step S4). When the drive of the pump 9 is stopped, the pressure difference between the ink supply path and the ink discharge path 40 decreases and in accordance with the decrease, the on-off valve 41 closes the opening 45 with the biasing force of the biasing member 42 as illustrated in FIG. 3. The discharging operation is ended in the above manner. Note that in the present embodiment, an example has been given in which the discharging operation is performed at a timing at which the ejection abnormality has been detected by the nozzle abnormality detection unit 60 while a printing operation based on a print job is performed; however, the present embodiment is not limited to the above timing. For example, the discharging operation may be performed at a timing at which an instruction from a user indicating an execution of the discharging operation is received through a printer driver or the like executed in an external device coupled to the printer 1, a timing after the power of the printer 1 has been activated and before the printing operation is performed, a timing after the cleaning operation has been performed with the capping mechanism 12, or the like.

As described above, in the printer 1 according to the present disclosure, in a state in which the on-off valve 41 closes the opening 45, a space between the ink supply path and the ink discharge path 40 in which the ink stagnates can be suppressed from being created. Accordingly, while the stagnation of ink is suppressed by having the on-off valve 41 close the opening 45 during normal times other than when the discharging operation is performed, when the discharging operation is performed, the foreign matter inside the ink supply path can be discharged through the ink discharge path 40 by opening the opening 45 by increasing the pressure difference between the ink supply path and the ink discharge path 40 with the drive of the pump 9. Furthermore, since the on-off valve 41 permits passage of the ink from the ink supply path side towards the ink discharge path 40 side and blocks passage of the ink from the ink discharge path 40 side towards the ink supply path side, even when the ink were to stagnate inside the ink discharge path 40, a backflow of the ink towards the ink supply path side is suppressed.

Furthermore, in the present embodiment, since the ink discharge path 40 is open in the ink supply path at a position on the filter 38 side with respect to the common liquid chamber 31 (specifically, in the communication flow path 39 of the filter unit 14), foreign matters positioned closer to the filter 38 can be discharged more easily. Furthermore, in the discharging operation, since the pressure inside the ink discharge path 40 is reduced while the pressure inside the ink supply path is increased so that a pressure difference is created therebetween, in other words, since the discharge of ink from the ink discharge path 40 is assisted by increasing the pressure inside the ink supply path, the on-off valve 41 is configured to open without any problems even when there is a restriction in the pressure value when decreasing the pressure inside the ink discharge path 40.

Note that a configuration can be adopted in which the on-off valve 41 is opened in the discharging operation by reducing the pressure inside the ink discharge path 40 without increasing the pressure inside the ink supply path. In such a case, even when the ink is stagnated inside the ink discharge path 40, the stagnated ink can be further suppressed from backflowing to the ink supply path side when the on-off valve 41 is opened. In other words, ink that has become thickened or ink in which solid components such as pigment and the like has been deposited due to being stagnated inside the ink discharge path 40 can be suppressed from entering the ink supply path. Furthermore, when the pressure on the ink supply path side is not increased in the discharging operation, foreign matters existing inside the ink supply path are suppressed from being sent to the nozzle 23 side; accordingly, difficulty in discharging the foreign matters can be prevented from occurring. In the above case, it is desirable that the pressure of the ink in the nozzles 23 be positive (in other words, higher than the atmospheric pressure) before the pressure inside the ink discharge path 40 is reduced. In such a case, even when ink is stagnated inside the ink discharge path 40, a backflow of the ink to the ink supply path side can be suppressed in a further effective manner when the on-off valve 41 is opened. Note that the pressure of the ink in the nozzles 23 can be, for example, adjusted by an adjusting unit of the sub tank 7 that adjusts the supply pressure of the ink to the recording head 8.

Furthermore, in a configuration in which the on-off valve 41 is opened by reducing the pressure inside the ink discharge path 40 and increasing the pressure inside the ink supply path, the timing to start increasing the pressure inside the ink supply path and the timing to start reducing the pressure inside the ink discharge path 40 can be differed. For example, the pressure inside the ink discharge path 40 may be reduced after increasing the pressure inside the ink supply path. In such a case, by increasing the pressure inside the ink supply path in advance when opening the on-off valve 41, the backflow of ink from the ink discharge path 40 side towards the ink supply path can be suppressed further. Furthermore, air bubbles can be further suppressed from being drawn into the ink supply path from the nozzles 23. Furthermore, for example, the pressure inside the ink supply path may be increased after reducing the pressure inside the ink discharge path 40. In such a case, by decreasing the pressure inside the ink discharge path 40 in advance when opening the on-off valve 41, the ink stagnated inside the ink discharge path 40 can be discharged more quickly.

Furthermore, in the above, a configuration in which the discharging operation is performed by supplying the ink into the ink supply path from the inflow port 35 side, which is upstream of the filter 38, has been described as an example; however, not limited to the above, a configuration may be adopted in which the discharging operation is performed by, in a state in which the nozzle formation surface is sealed with the cap 13, having the ink flow into the cap 13 and, further, be sent to the ink supply path from the nozzles 23 of the recording head 8. In such a case, in the flow path upstream the filter 38, a valve of the adjusting unit provided inside the sub tank 7 may close the flow path so that the pressure in the ink supply path do not escape to the outside from the inflow port 35 side.

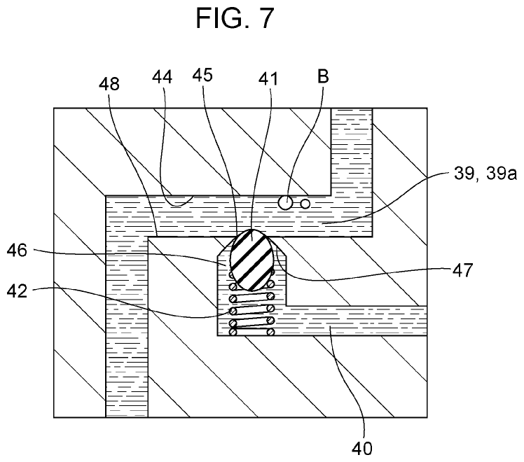

FIG. 7 is an enlarged view illustrating a coupling portion between the ink supply path and the ink discharge path 40, according to a first modification. Note that the valve closed state in which the on-off valve 41 is closed is depicted in FIG. 7. In the first embodiment described above, a configuration in which the ink discharge path 40 is in communication with the upper surface 44 that is, among the wall surfaces defining the lateral passage 39a of the communication flow path 39 in the ink supply path, positioned on the upper side in the gravitational direction has been described as an example; however, the configuration is not limited to such a configuration. In the modification in FIG. 7, the ink discharge path 40 is in communication with a lower surface 48 that is, among the wall surfaces defining the lateral passage 39a of the communication flow path 39, positioned on the lower side in the gravitational direction. The above communicating portion is the opening 45. Note that other configurations are similar to those of the first embodiment described above. According to the above configuration, since the opening 45 is formed in the lower surface 48 of the lateral passage 39a in the ink supply path, when an air bubble B flows in the ink supply path, the air bubble B will rise up above the lower surface 48 to the upper surface 44 side due to the buoyancy of the air bubble B; accordingly, a stagnation of the air bubble B is not easily created in the opening 45.

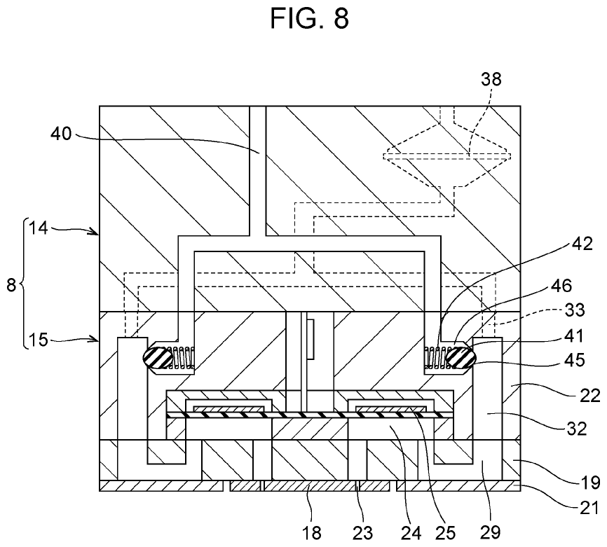

FIG. 8 is a cross-sectional view of the recording head 8 according to a second modification. The modification is different from that of the first embodiment described above in that the ink discharge path 40 is open in the common liquid chambers 31 in the ink supply path. In the modification in FIG. 8, the ink discharge path 40 is in communication with inner wall surfaces of the introduction liquid chambers 32 of the case 22. The above communicating portions are openings 45. Since two common liquid chambers 31 are provided in the head unit 15, the ink discharge path 40 is coupled to the introduction liquid chamber 32 of each common liquid chamber 31. Each opening 45 is configured to open and close with the on-off valve 41. Note that other configurations are similar to those of the first embodiment described above. According to such a configuration, compared with the configuration of the first embodiment described above, since the ink discharge path 40 is coupled in the common liquid chambers 31 at positions closer to the nozzles 23 to form the openings 45, foreign matters existing closer to the nozzles 23 can be discharged more easily with the discharging operation. Foreign matters in the ink supply path become easily stagnated particularly in the common liquid chambers 31 having volumes larger than other portions in the ink supply path. The above foreign matters can be discharged effectively. Furthermore, by coupling the ink discharge path 40 to the common liquid chambers 31 at positions on the upper side in the gravitational direction (in other words, at positions closer to the introduction openings 33), when air bubbles as foreign matters flow into the common liquid chambers 31, the air bubbles rising up due to buoyancy can be discharged more easily with the discharging operation.

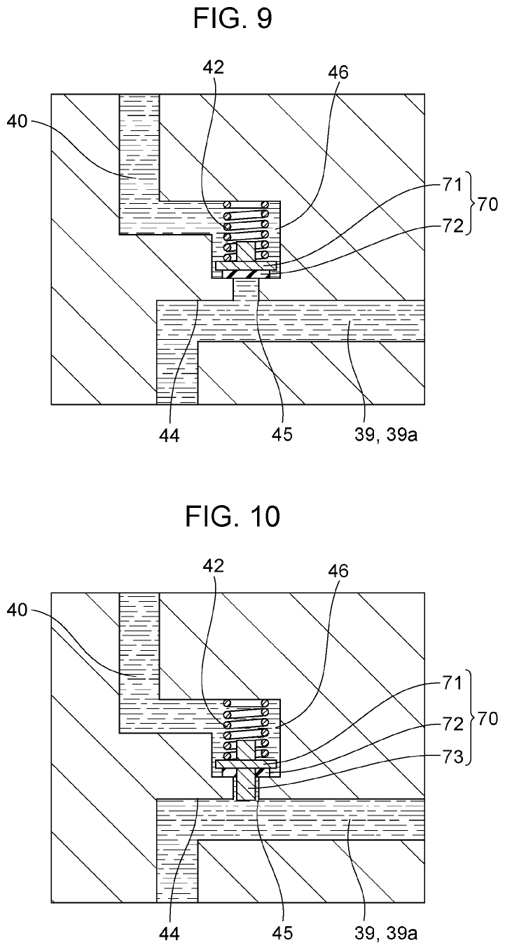

FIG. 9 is an enlarged view illustrating a coupling portion between the ink supply path and the ink discharge path 40, according to a third modification. A configuration in which the on-off valve 41 has a prolate spheroid shape elongated in the opening and closing direction has been described as an example in the first embodiment described above; however, not limited to the above, any on-off valves with various known configurations that are configured to open and close the opening 45 can be used. For example, in the third modification in FIG. 9, an on-off valve 70 includes a valve body 71 and a sealing member 72. The sealing member 72 is fabricated of an elastic material such as an elastomer, and the valve body 71 is fabricated of a synthetic resin, metal, or the like that is harder than the sealing member 72. The valve body 71 is a disk-shaped member having an area that is larger than the opening area of the opening 45. The sealing member 72 having elasticity, such as an elastomer, is attached to a surface of the valve body 71 opposing the opening 45. Furthermore, the valve body 71 is biased towards the opening 45 side with the biasing member 42 from a back side, which is a side opposite the side on which the sealing member 72 is provided. Furthermore, when the valve is closed, the opening peripheral portion of the opening 45 is sealed in a liquid tight manner with the sealing member 72 adhered to the peripheral portion of the opening 45 with the elasticity of the sealing member 72. In other words, the sealing member 72 adheres to the peripheral portion of the opening 45 while the on-off valve 41 is in a closed state. Note that other configurations are similar to those of the first embodiment described above.

FIG. 10 is an enlarged view illustrating a coupling portion between the ink supply path and the ink discharge path 40, according to a fourth modification. The fourth modification has a point in common with the third modification in that the on-off valve 70 includes the valve body 71 and the sealing member 72; however, the fourth modification is different from the third modification in that the on-off valve 70 further includes a shaft portion 73. The shaft portion 73 is a columnar member integrally formed with the valve body 71. The shaft portion 73 penetrates the sealing member 72 and protrudes to the opening 45 side with respect to the sealing member 72. A diameter of a cross section of the shaft portion 73 is set smaller than an inner diameter of the opening 45. Furthermore, when the valve is closed, the shaft portion 73 passing inside the opening 45 is configured to protrude on the ink supply path side with respect to the portion of the sealing member 72 abutting against the peripheral portion of the opening 45. Note that other configurations are similar to those of the third modification described above. A space in the coupling portion between the ink supply path and the ink discharge path 40 where the ink becomes stagnated in the valve closed state can be reduced further with the above configuration. With the above, a stagnation of the ink in the opening 45 that is a coupling portion between the ink supply path and the ink discharge path 40 can be suppressed further.

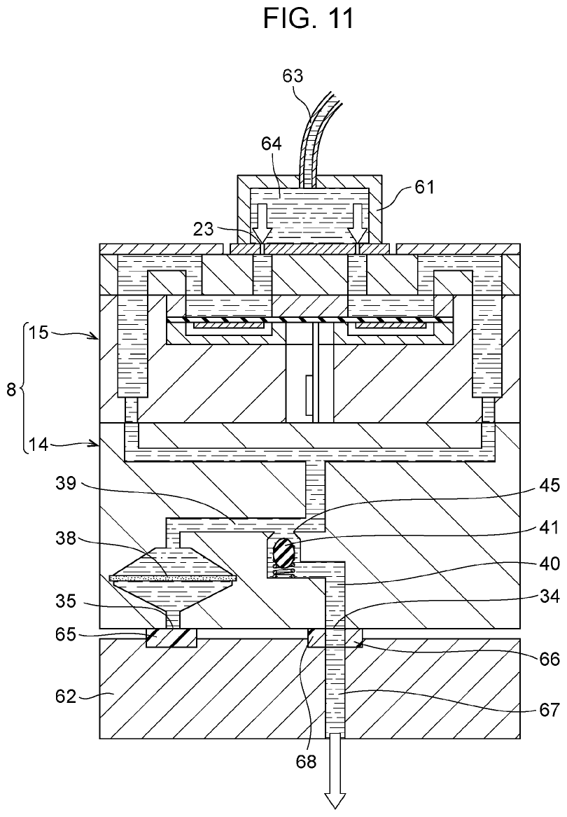

FIG. 11 is a diagram illustrating a cleaning method and a method of manufacturing the recording head 8 according to a second embodiment of the present disclosure, and is a schematic diagram illustrating a configuration of a cleaning device that cleans the ink supply path of the recording head 8. In the present embodiment, a case in which the ink supply path of the recording head 8 is cleaned with the cleaning device when a foreign matter has entered into the ink supply path during the manufacturing process of the recording head 8 will be described. The cleaning device described as an example includes a cleaning cap 61 and a flow-path attachment 62. The cleaning cap 61 is a member that seals the nozzle formation surface of the recording head 8. The cleaning cap 61 is formed with an elastic member such as an elastomer to have a tray-like shape in which the side of a contact surface in contact with the nozzle formation surface is open so as to seal the nozzle formation surface in a liquid tight manner. Furthermore, in a state in which the nozzle formation surface is sealed with the cleaning cap 61, the nozzles 23 are disposed inside the cleaning cap 61. The cleaning cap 61 is configured so that cleaning solution 64 from a cleaning solution tank (not shown) flows into the cleaning cap 61 through a solution sending pipe 63. An ink solvent (containing no coloring material) or solution in which a surfactant has been diluted in pure water, for example, may be used as the cleaning solution 64.

Meanwhile, the flow-path attachment 62 is attached to the inflow port 35 side and the discharge port 34 side of the filter unit 14 in the recording head 8. The flow-path attachment 62 is a block-shaped member in which an output passage 67 is formed. A sealing portion 65 and a communicating portion 66 are provided in an attachment surface between the flow-path attachment 62 and the filter unit 14 at positions corresponding to the inflow port 35 and the discharge port 34, respectively, of the filter unit 14. The sealing portion 65 and the communicating portion 66 are each formed by an elastic member such as an elastomer. In a state in which the flow-path attachment 62 is attached to the filter unit 14 of the recording head 8, the sealing portion 65 adheres to the periphery of the opening of the inflow port 35 of the filter unit 14 and seals the inflow port 35 in a liquid tight manner. Furthermore, a communication passage 68 is formed inside the communicating portion 66 and communicates the discharge port 34 of the head unit and the output passage 67 to each other through the communication passage 68 in a liquid tight manner. A portion downstream of the output passage 67 in the flow-path attachment 62 is coupled to a waste liquid tank, for example.

In the above configuration, the cleaning solution 64 flows into the cleaning cap 61 from the cleaning solution tank through the solution sending pipe 63 and is sent to the ink supply path from the nozzles 23 of the recording head 8; accordingly, the pressure inside the ink supply path is increased. With the above, a pressure difference is created between the ink supply path and the ink discharge path 40, and when the conditions set by expression (1) described above are satisfied, the on-off valve 41 is opened. The pressure inside the ink supply path may be increased and the pressure inside the ink discharge path 40 may be reduced in the present embodiment as well. In other words, the pressure in the ink discharge path 40 may be reduced through the output passage 67 of the flow-path attachment 62. Note that in the present embodiment, since the inflow port 35 of the filter unit 14 is sealed by the sealing portion 65, the pressure in the ink supply path does not escape to the outside through the inflow port 35. Furthermore, when the on-off valve 41 is opened and when there is a foreign matter in the ink supply path, the foreign matter is discharged together with the cleaning solution 64 to the ink discharge path 40 side through the opening 45 and, further, is discharged to a portion external to the recording head 8 through the output passage 67 of the flow-path attachment 62. For example, when an amount of cleaning solution 64 equivalent to or larger than the volume of the ink supply path is distributed and when the passage of the solution is stopped, the on-off valve 41 closes the opening 45 with the biasing force of the biasing member 42. Cleaning of the recording head 8 ends in the above manner. After the cleaning, a process and the like that replaces the cleaning solution 64 inside the ink supply path with ink is performed.

In the present embodiment, the inside of the ink supply path can be made more cleaner by supplying the cleaning solution 64, which is a type of liquid, into the ink supply path from the nozzle 23 side and discharging the cleaning solution from the ink discharge path 40. Furthermore, when a foreign matter has entered the ink supply path in the manufacturing process of the recording head 8, the foreign matter inside the ink supply path can be discharged without removing the filter 38. Application of such a cleaning method is not limited to when the recording head 8 is manufactured and can also be applied in a similar manner when the recording head 8 that has been mounted once in the printer 1 is removed and maintenance is performed.

Other than the above, the present disclosure can also be applied to a liquid ejecting head that includes a liquid supply path extending from the filter to the nozzles and that ejects a liquid from the nozzles, to a liquid ejecting apparatus that includes the liquid ejecting head, to a liquid ejecting head cleaning method, and to a liquid ejecting head manufacturing method. For example, the present disclosure can also be applied to a liquid ejecting head including a plurality of coloring material ejecting heads used to manufacture color filters of liquid crystal displays and the like, a plurality of electrode material ejecting heads used to form electrodes of organic electroluminescence (EL) displays and field emission displays (FED), a plurality of bio organic matter ejecting heads used to manufacture biochips (biotips), or the like, and to a liquid ejecting apparatus including the liquid ejecting head.

What is claimed is:

1. A liquid ejecting head comprising:
a nozzle that ejects a liquid;
a liquid supply path that supplies the liquid to the nozzle;
a filter that filters the liquid flowing in the liquid supply path; and
a liquid discharge path that is coupled to the liquid supply path between the filter and the nozzle through an opening, wherein
the liquid discharge path includes an on-off valve that opens and closes the opening, and
while the on-off valve permits passage of the liquid from a liquid supply path side to a liquid discharge path side, the on-off valve blocks passage of the liquid from the liquid discharge path side to the liquid supply path side.

2. The liquid ejecting head according to claim 1, wherein
S×P1s<F≤S×(P1d−P2)
is satisfied, where F [N] is force in which the on-off valve closes the opening, P1d [Pa] is a maximum pressure generated in the liquid inside the liquid supply path when a discharging operation that discharges the liquid inside the liquid supply path through the liquid discharge path is performed, P1s [Pa] is a maximum pressure of the liquid inside the liquid supply path other than when the discharging operation is performed, P2 [Pa] is a minimum pressure of the liquid inside the liquid discharge path when the discharging operation is performed, and S [m²] is an area of the opening (note that a negative pressure takes a negative value).

3. The liquid ejecting head according to claim 1, wherein
the opening is formed in a lower surface of the liquid supply path in a gravitational direction.

4. The liquid ejecting head according to claim 1, wherein
the opening is formed in an upper surface of the liquid supply path in a gravitational direction.

5. The liquid ejecting head according to claim 1, wherein
a portion of the on-off valve protrudes to the liquid supply path side with respect to a portion where the on-off valve abuts against a peripheral portion of the opening when the opening is closed.

6. The liquid ejecting head according to claim 1, wherein
the liquid supply path includes a common liquid chamber commonly provided to a plurality of the nozzles, and
the liquid discharge path includes the opening at a position in the liquid supply path that is on a filter side with respect to the common liquid chamber.

7. The liquid ejecting head according to claim 1, wherein
the liquid supply path includes a common liquid chamber commonly provided to a plurality of the nozzles, and
the liquid discharge path is open inside the common liquid chamber.

8. The liquid ejecting head according to claim 1, wherein
an area of the opening is smaller than a sectional area of the liquid supply path at a position where the opening is formed.

9. The liquid ejecting head according to claim 1, wherein
an area of the opening is smaller than an opening area of the nozzle.

10. A liquid ejecting apparatus comprising:
the liquid ejecting head according to claim 1;
a pump that creates a pressure difference between the liquid discharge path and the liquid supply path; and
a sealing member that seals a surface of the liquid ejecting head in which the nozzle is formed.

11. A liquid ejecting head cleaning method that cleans the liquid ejecting head according to claim 1, the method comprising:
performing a discharging operation that discharges a liquid inside the liquid supply path to the liquid discharge path side through the opening by creating a pressure difference between the liquid discharge path and the liquid supply path and opening the on-off valve.

12. The liquid ejecting head cleaning method according to claim 11, wherein
in the discharging operation, the pressure difference is created by reducing a pressure inside the liquid discharge path

13. The liquid ejecting head cleaning method according to claim 12, wherein
a pressure of the liquid in the nozzle is positive before the pressure inside the liquid discharge path is reduced.

14. The liquid ejecting head cleaning method according to claim 11, wherein
in the discharging operation, the pressure difference is created by both reducing a pressure inside the liquid discharge path and increasing a pressure inside the liquid supply path.

15. The liquid ejecting head cleaning method according to claim 14, wherein
the pressure inside the liquid discharge path is reduced after the pressure inside the liquid supply path has been increased.

16. The liquid ejecting head cleaning method according to claim 14, wherein
the pressure inside the liquid supply path is increased after the pressure inside the liquid discharge path has been reduced.

17. The liquid ejecting head cleaning method according to claim 11, wherein
a surface of the liquid ejecting head in which the nozzle is formed is sealed with a sealing member before the discharging operation.

18. The liquid ejecting head cleaning method according to claim 11, wherein
in the discharging operation, the liquid is supplied into the liquid supply path form a nozzle side and the liquid is discharged from the liquid discharge path.

19. A liquid ejecting head manufacturing method comprising:
applying the liquid ejecting head cleaning method according to claim 11.
